(19) United States
(12) Patent Application Publication
(10) Pub. No.: US 2013/0147131 A1
(43) Pub. Date: Jun. 13, 2013

(54) Rotary Stage With Integrated Collet Closer Assembly

(71) Applicant: Wesley Mitchell, Glenshaw, PA (US)

(72) Inventor: Wesley Mitchell, Glenshaw, PA (US)

(73) Assignee: AEROTECH, INC., Pittsburgh, PA (US)

(21) Appl. No.: 13/571,658

(22) Filed: Aug. 10, 2012

Related U.S. Application Data
(60) Provisional application No. 61/568,316, filed on Dec. 8, 2011.

(51) Int. Cl. B23B 31/30; B23B 31/20

(52) U.S. Cl. 279/4.09; 279/4.07

(57) ABSTRACT

A rotary stage having an integrated collet closure assembly includes: an actuating piston positioned in a piston housing; a drawbar configured to be moved axially depending on the position of the actuating piston to open and close the collet closure assembly, and rotationally by movement of a rotating shaft of the rotary stage; and a pair of thrust bearings provided between the actuating piston and the drawbar. The pair of thrust bearings acts as an interface between the actuating piston and the drawbar such that the drawbar rotates freely and the actuating piston and the piston housing remain stationary in a rotary direction.

### CROSS REFERENCE TO RELATED APPLICATIONS

This application claims benefit of U.S. Provisional Patent Application No. 61/568,316 entitled “Rotary Stage with Integrated Collet Closer Assembly” filed Dec. 8, 2011, which is hereby incorporated by reference in its entirety.

### BACKGROUND OF THE INVENTION

1. Field of the Invention

The present disclosure is generally directed to collet chuck assemblies and, more particularly, to a collet closer assembly that is integrated with a rotary stage.

2. Description of Related Art

Collet closer assemblies are known and used frequently in machine tools and laser processing to hold a workpiece during rotation of the workpiece. Several conventional collet closer assembly examples include Zagar Incorporated Air/Hydraulic Rotating Holding Fixture, Atlas Workholding ATL206-5C, and Royal Products 5C Pneumatic Collet Closer Assembly.

Conventional collet closer mechanisms typically include an actuating piston for actuating a collet sleeve of the collet closer mechanism to either open or close a collet around a workpiece. The Zagar and Atlas devices mentioned above further require the actuating piston to be rotating while the outer housing is restrained from rotary motion. The piston is separated from the outer housing by either a set of angular contact bearings or a pair of deep groove radial bearings. Such a configuration requires rotary seals to transfer the air pressure to the piston for actuation. This is usually accomplished with O-rings or lip seals. The rotary seals cause significant friction. The friction causes increased heat generation, the need to use larger motors (due to frictional torque), and a decrease in positioning accuracy.

The Royal Products mechanism includes an actuating piston and a drawbar configured to open or close a collet assembly. The Royal Products 5C Pneumatic Collet Closer Assembly uses two sets of angular contact bearings to separate the drawbar from the actuating piston. In a typical lathe application, the whole assembly is adapted to fit the rear of the rotating spindle. The whole assembly must then be held up by the spindle bearings. Also, the Royal Products configuration has additional inertia due to the spindle adapter and it has additional rotary friction due to the preload in the angular contact ball bearings.

Accordingly, a need exists for a collet closer assembly that is integrated with a rotary stage, thereby eliminating the need for the use of rotary seals and eliminating additional load to the spindle bearings.

### SUMMARY OF THE INVENTION

Provided is a rotary stage that includes: a stage housing; a rotating stage shaft positioned within the housing; a collet assembly received by the rotating stage shaft; a piston housing provided at a rearward end of the stage housing; an actuating piston positioned in the piston housing; a drawbar extending between the piston housing and the rotating stage shaft and configured to be moved axially within the piston housing and the rotating stage shaft depending on the position of the actuating piston to open and close the collet assembly; and a pair of thrust bearings provided between the actuating piston and the drawbar. The pair of thrust bearings acts as an interface between the actuating piston and the drawbar such that the drawbar rotates freely and the actuating piston and the piston housing remain stationary in a rotary direction. Accordingly, the need for rotational seals that increase running friction are eliminated.

The piston housing may further include a first air inlet and a second air inlet. Pneumatic pressure may be provided to the first air inlet to cause the actuating piston to move in a first direction and pneumatic pressure may be provided to the second air inlet to cause the actuating piston to move in a second direction that is opposite to the first direction. The movement of the actuating piston in the first direction may cause the drawbar to be moved axially within the stage housing and the rotating stage shaft to close the collet assembly and movement of the actuating piston in the second direction may cause the drawbar to be moved axially within the stage housing and the rotating stage shaft to open the collet assembly.

The rotary stage may further include a motor positioned within the stage housing to cause the rotating stage shaft to rotate, such as a rotary brushless rare-earth magnet servomotor. However, this is not to be construed as limiting the present invention as any suitable motor may be utilized.

The collet assembly may include a collet and a collet sleeve positioned around the collet such that axial movement of the collet sleeve causes the collet to open and close. The drawbar and the collet sleeve may be configured to move axially upon actuation of the actuating piston and rotationally based upon movement of the rotating stage shaft.

Also provided is a workpiece supporting and manipulating device that includes a rotary stage and a collet closure assembly integrated with the rotary stage. The rotary stage includes a stage housing and a rotating stage shaft positioned within the housing. The collet closure assembly includes: a collet and collet sleeve positioned within and supported by the rotating stage shaft; a piston housing provided at a rearward end of the stage housing; an actuating piston positioned in the piston housing; a drawbar extending between the piston housing and the rotating stage shaft and configured to be moved axially within the piston housing and the rotating stage shaft depending on the position of the actuating piston to cause the collet sleeve to open and close the collet; and a pair of thrust bearings provided between the actuating piston and the drawbar. The pair of thrust bearings acts as an interface between the actuating piston and the drawbar such that the drawbar rotates freely and the actuating piston and the piston housing remain stationary in a rotary direction.

In addition, provided is a rotary stage having an integrated collet closure assembly that includes: an actuating piston positioned in a piston housing; a drawbar configured to be moved axially depending on the position of the actuating piston to open and close the collet closure assembly, and rotationally by movement of a rotating shaft of the rotary stage; and a pair of thrust bearings provided between the actuating piston and the drawbar. The pair of thrust bearings acts as an interface between the actuating piston and the drawbar such that the drawbar rotates freely and the actuating piston and the piston housing remain stationary in a rotary direction.

These and other features and characteristics of the present invention, as well as the methods of operation and functions of the related elements of structures, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of a rotary stage with an integrated collet closer assembly in accordance with the present invention;

FIG. 2 is a front view of the rotary stage with the integrated collet closer assembly of FIG. 1;

FIG. 3 is a cross-sectional view of the rotary stage with the integrated collet closer assembly of FIG. 2 taken along line A-A.

FIG. 4 is a cross-sectional view of the rotary stage with the integrated collet closer assembly with the collet closer assembly in a closed position; and

FIG. 5 is a cross-sectional view of the rotary stage with the integrated collet closer assembly with the collet closer assembly in an open position.

### DESCRIPTION OF THE PREFERRED EMBODIMENTS

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification are simply exemplary embodiments of the invention. Hence, specific dimensions and other physical characteristics related to the embodiments disclosed herein are not to be considered as limiting.

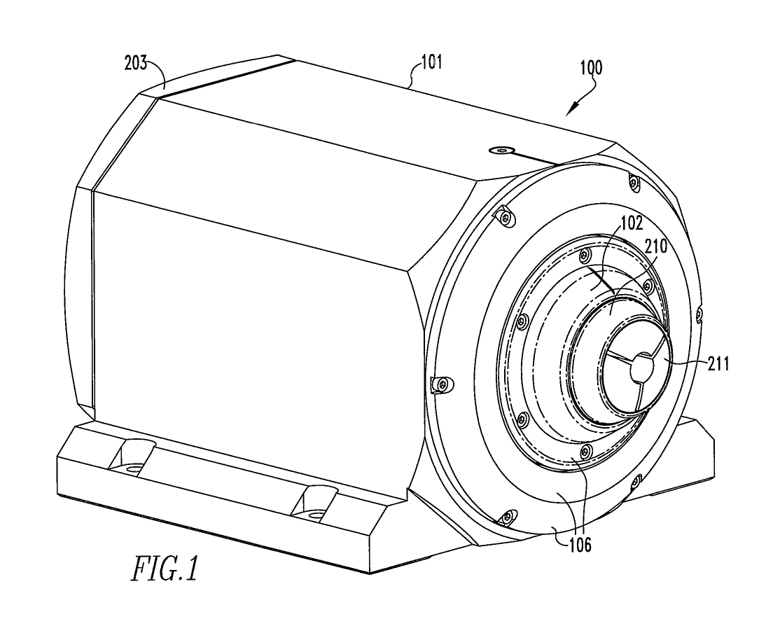

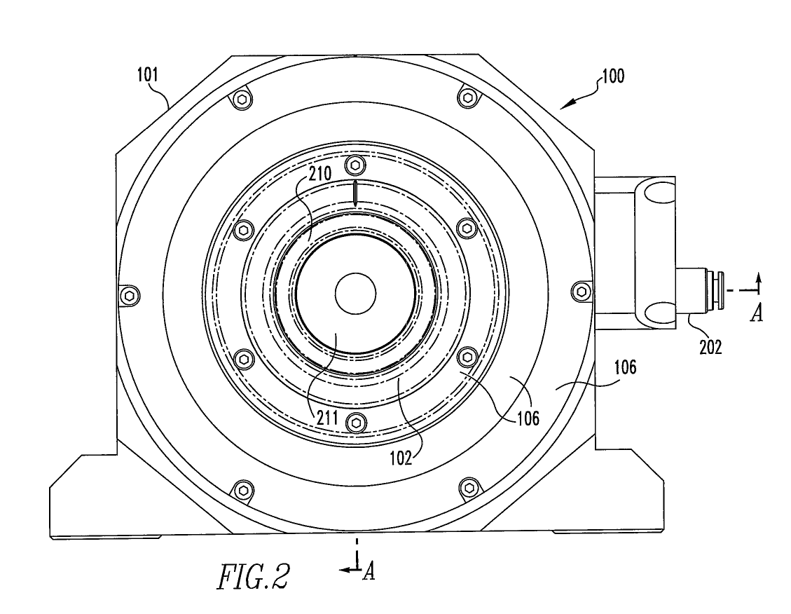

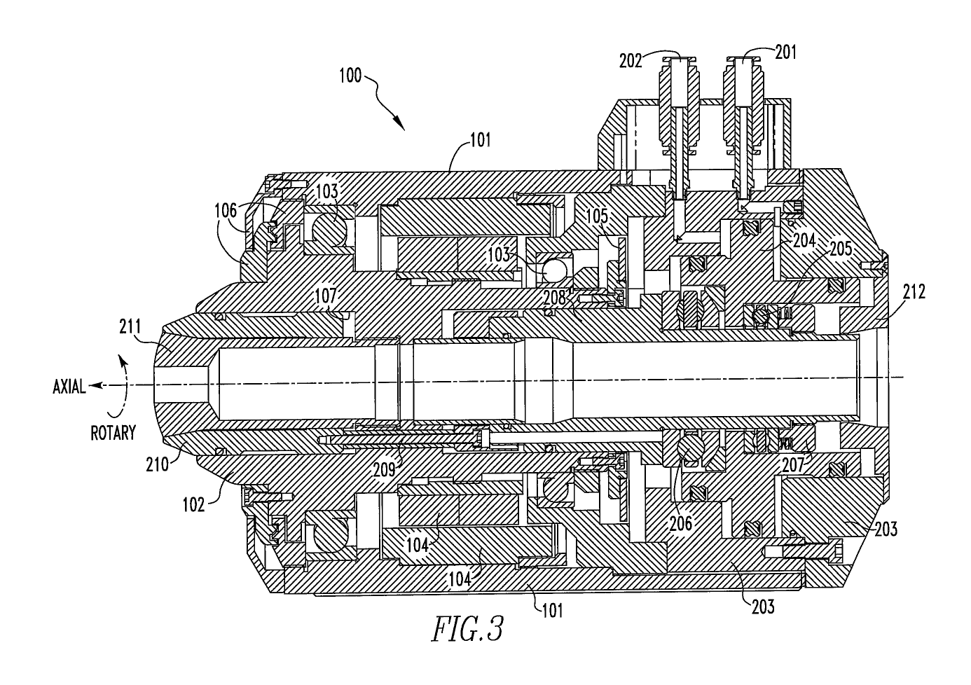

With reference to FIGS. 1-3, a rotary stage having an integrated collet closer assembly, generally denoted as reference numeral 100, includes a stage housing 101; a rotating stage shaft 102 positioned within the housing 101; and a motor 104 positioned within the stage housing 101 to cause the rotating stage shaft 102 to rotate. The rotating stage shaft 102 has an axial bore 107 for accommodating a collet assembly and a workpiece.

The motor 104 may be a rotary brushless rare-earth magnet servomotor. However, this is not to be construed as limiting the present invention as any suitable motor may be utilized.

A pair of rotary bearings 103 is provided between the rotating stage shaft 102 and the housing 101 to allow relative rotary motion between the stationary stage housing 101 and the rotating shaft 102 during operation. An encoder 105 is provided on the rearward end of the rotating stage shaft 102 to provide positional feedback to a controller (not shown) of the motor 104. In addition, a labyrinth seal 106 is provided to enclose and seal the front face of the stage housing 101.

The rotary stage having an integrated collet closer assembly 100 further includes a collet assembly. The collet assembly includes collet 211 and a collet sleeve 210 surrounding the collet 211. The collet 211 and collet sleeve 210 are positioned within the axial bore 107 of the rotating stage shaft 102. The collet sleeve 210 is positioned around the collet 211 and axial movement of the collet sleeve 210 causes the collet 211 to either close to clamp a workpiece or open to release a workpiece.

A pneumatically actuated piston 204 is positioned within a piston housing 203 provided at a rearward end of the stage housing 101. The piston housing 203 includes a first air inlet 201 and a second air inlet 202 to receive pneumatic pressure to actuate the piston 204. A drawbar 208 extends between the piston housing 203 and the rotating stage shaft 102 and is configured to be moved axially within the shaft 102 depending on the position of the piston 204. The drawbar 208 is connected to the collet sleeve 210 by a collet sleeve spacer 209 such that axial movement of the drawbar 208 causes axial movement of the collet sleeve 210 to open and close the collet 211. The rearward end of the piston housing 203 is covered with a rear cover 212.

A pair of thrust bearings 205, 206 is provided between the actuating piston 204 and the drawbar 208. The pair of thrust bearings 205, 206 acts as an interface between the actuating piston 204 and the drawbar 208 such that the drawbar 208 rotates freely and the actuating piston 204 and the piston housing 203 remain stationary in a rotary direction. The thrust bearings 205, 206 are firmly held in place by a thrust bearing retainer nut 207.

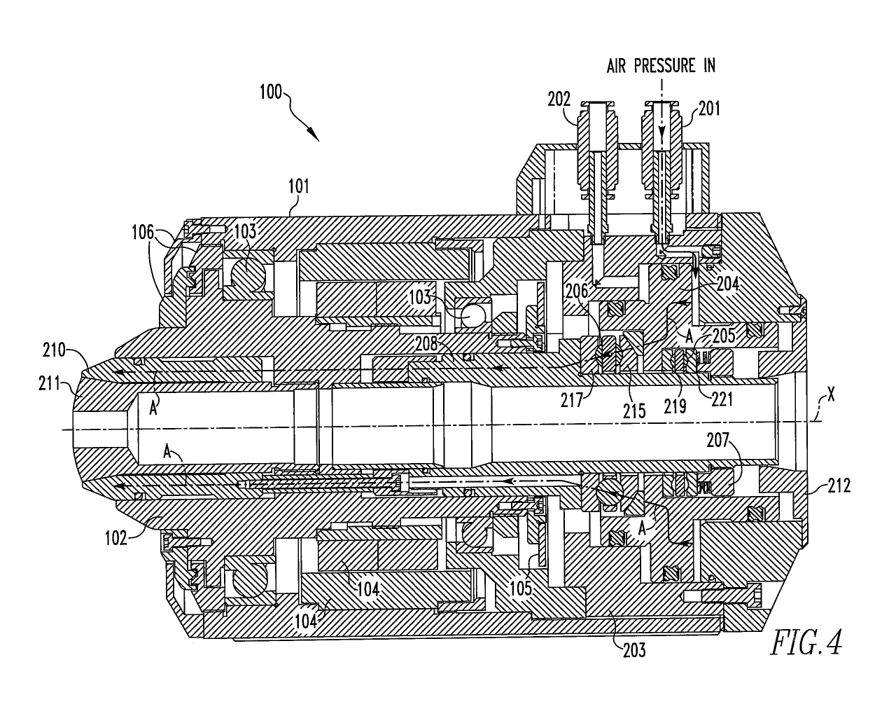

With reference to FIG. 4 and with continuing reference to FIGS. 1-3, in operation, pneumatic pressure is provided to the first air inlet 201 to cause the actuating piston 204 to move axially in a first direction towards the front end of the stage housing 101 within the stationary piston housing 203. The movement of the actuating piston 204 in the first direction causes the drawbar 208 to be moved axially along longitudinal axis X and in the direction of arrow A within the stage housing 101 and the piston housing 203. This movement of the drawbar 208 causes the collet sleeve 210 to axially move to close the collet 211 around a workpiece (not shown). More specifically, the axially translating piston 204 presses on the thrust bearing 206. The piston 204 and thrust bearing raceway touching the piston 215 translate axially only (i.e., they do not rotate). The force is transferred through the ball bearings of the thrust bearing 206 and into the thrust bearing raceway that is touching the drawbar 217. The drawbar 208, raceway touching the drawbar 217, and the ball bearings of the thrust bearing 206 translate axially and rotate. The drawbar 208 is in turn attached to the collet sleeve 210 as described hereinabove. Alternatively, the drawbar 208 could be attached directly to the collet 211. In such a configuration, the collet sleeve 210 would be stationary and the collet 211 would move axially to interface with the collet sleeve 210 taper. In either configuration, the collet sleeve 210 has a taper which interfaces with the collet 211. The axial motion of the sleeve 210 compresses the collet 211 and clamps a workpiece.

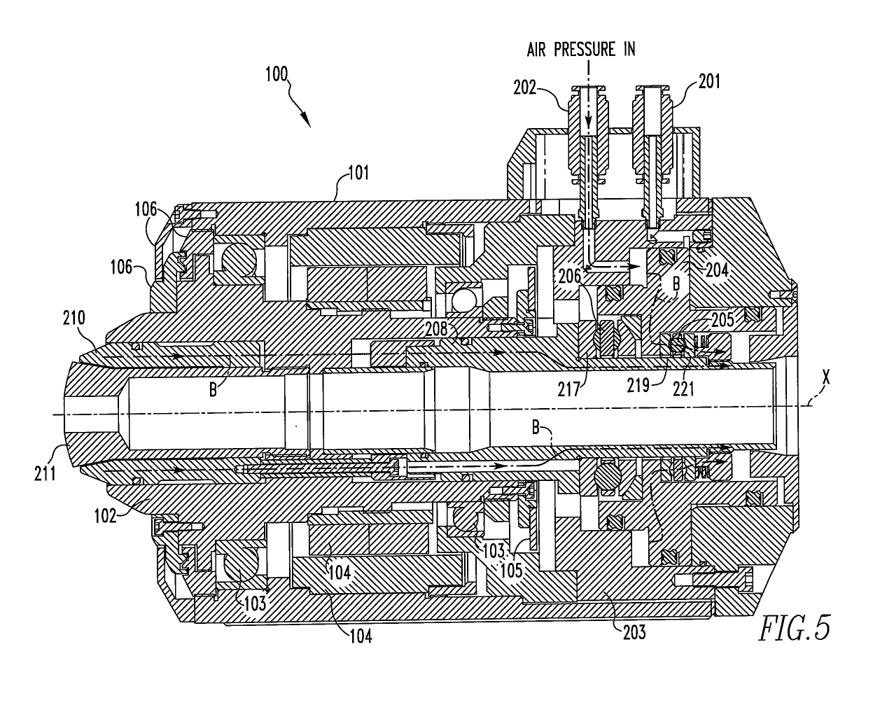

With reference to FIG. 5 and with continuing reference to FIGS. 1-3, pneumatic pressure is provided to the second air inlet 202 to open the collet 211. The pneumatic pressure causes the actuating piston 204 to move in a second direction that is opposite to the first direction causing the drawbar 208 to be moved axially along longitudinal axis X and in the direction of arrow B within the stage housing 101 and the piston housing 203. This movement of the drawbar 208 causes the collet sleeve 210 to axially move to open the collet 211. More specifically, the axially translating piston 204 presses on the thrust bearing 205. The piston 204 and thrust bearing raceway touching the piston 219 translate axially only (i.e., they do not rotate). The force is transferred through the ball bearings of the thrust bearing 205 and into the thrust bearing raceway that is touching the drawbar 221. The drawbar 208, raceway touching the drawbar 221, and the ball bearings of the thrust bearing 205 translate axially and rotate. The drawbar 208 is, in turn, attached to the collet sleeve 210 as described hereinabove. The collet sleeve 210 has a taper which interfaces with the collet 211. The axial motion of the sleeve 210 away from the collet 211 opens the collet 211 and releases the workpiece.

Accordingly, during operation, the stage housing 101 and the motor 104 of the rotary stage and the piston housing 203, rear cover 212, and first and second air inlets 201, 202 of the collet closure assembly remain stationary. The stage shaft 102, rotary bearings 103, and the encoder 105 of the rotary stage rotate around the longitudinal axis X thereof. The piston 204 moves only axially along the longitudinal axis X and does not rotate. The thrust bearings 205, 206, drawbar 208, and the collet sleeve 210 all move axially along the longitudinal axis X and rotate around the longitudinal axis X.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A rotary stage comprising:
a stage housing;
a rotating stage shaft positioned within the housing;
a collet assembly received by the rotating stage shaft;
a piston housing provided at a rearward end of the stage housing;
an actuating piston positioned in the piston housing;
a drawbar extending between the piston housing and the rotating stage shaft and configured to be moved axially within the piston housing and the rotating stage shaft depending on the position of the actuating piston to open and close the collet assembly; and
a pair of thrust bearings provided between the actuating piston and the drawbar,
wherein the pair of thrust bearings acts as an interface between the actuating piston and the drawbar such that the drawbar rotates freely and the actuating piston and the piston housing remain stationary in a rotary direction.

2. The rotary stage of claim 1, wherein the piston housing further includes a first air inlet and a second air inlet.

3. The rotary stage of claim 2, wherein pneumatic pressure is provided to the first air inlet to cause the actuating piston to move in a first direction and pneumatic pressure is provided to the second air inlet to cause the actuating piston to move in a second direction that is opposite to the first direction.

4. The rotary stage of claim 3, wherein the movement of the actuating piston in the first direction causes the drawbar to be moved axially within the rotating stage shaft and the piston housing to close the collet assembly and movement of the actuating piston in the second direction causes the drawbar to be moved axially within the rotating stage shaft and the piston housing to open the collet assembly.

5. The rotary stage of claim 1, further comprising a motor positioned within the stage housing to cause the rotating stage shaft to rotate.

6. The rotary stage of claim 5, wherein the motor is a rotary brushless rare-earth magnet servomotor.

7. The rotary stage of claim 1, wherein the collet assembly comprises a collet and a collet sleeve positioned around the collet such that axial movement of the collet sleeve causes the collet to open and close.

8. The rotary stage of claim 7, wherein the drawbar and the collet sleeve are configured to move axially upon actuation of the actuating piston and rotationally based upon movement of the rotating stage shaft.

9. A workpiece supporting and manipulating device comprising:
a rotary stage comprising:
a stage housing; and
a rotating stage shaft positioned within the housing; and
a collet closure assembly integrated with the rotary stage, the collet closure assembly comprising:
a collet and collet sleeve positioned within and supported by the rotating stage shaft;
a piston housing provided at a rearward end of the stage housing;
an actuating piston positioned in the piston housing;
a drawbar extending between the piston housing and the rotating stage shaft and configured to be moved axially within the piston housing and the rotating stage shaft depending on the position of the actuating piston to cause the collet sleeve to open and close the collet; and
a pair of thrust bearings provided between the actuating piston and the drawbar,
wherein the pair of thrust bearings acts as an interface between the actuating piston and the drawbar such that the drawbar rotates freely and the actuating piston and the piston housing remain stationary in a rotary direction.

10. The device of claim 9, wherein the piston housing further includes a first air inlet and a second air inlet.

11. The device of claim 10, wherein pneumatic pressure is provided to the first air inlet to cause the actuating piston to move in a first direction and pneumatic pressure is provided to the second air inlet to cause the actuating piston to move in a second direction that is opposite to the first direction.

12. The device of claim 11, wherein the movement of the actuating piston in the first direction causes the drawbar to be moved axially within the rotating stage shaft and the piston housing to close the collet assembly and movement of the actuating piston in the second direction causes the drawbar to be moved axially within the stage housing and the piston housing to open the collet assembly.

13. The device of claim 9, wherein the rotary stage further comprises a motor positioned within the stage housing to cause the rotating stage shaft to rotate.

14. The device of claim 13, wherein the motor is a rotary brushless rare-earth magnet servomotor.

15. The device of claim 9, wherein the collet assembly comprises a collet and a collet sleeve positioned around the collet such that axial movement of the collet sleeve causes the collet to open and close.

16. The device of claim 15, wherein the drawbar and the collet sleeve are configured to move axially upon actuation of the actuating piston and rotationally based upon movement of the rotating stage shaft.

17. A rotary stage having an integrated collet closure assembly comprising:
an actuating piston positioned in a piston housing;
a drawbar configured to be moved axially depending on the position of the actuating piston to open and close the collet closure assembly, and rotationally by movement of a rotating shaft of the rotary stage; and
a pair of thrust bearings provided between the actuating piston and the drawbar,
wherein the pair of thrust bearings acts as an interface between the actuating piston and the drawbar such that the drawbar rotates freely and the actuating piston and the piston housing remain stationary in a rotary direction.

18. The rotary stage of claim 17, further comprising a motor to cause the rotating stage shaft to rotate.

19. The rotary stage of claim 17, wherein the collet closure assembly comprises a collet and a collet sleeve positioned around the collet such that axial movement of the collet sleeve causes the collet to open and close.

20. The rotary stage of claim 19, wherein the drawbar and the collet sleeve are configured to move axially upon actuation of the actuating piston and rotationally based upon movement of the rotating stage shaft.
